(19) United States
(12) Patent Application Publication
(10) Pub. No.: US 2009/0077410 A1
(43) Pub. Date: Mar. 19, 2009

(54) METHOD FOR SETTING ACTUAL OPERTATION FREQUENCY OF MEMORY AND SETTING MODULE THEREOF

(75) Inventors: Bing-Min Lin, Taipei (TW); Chin-Fu Ho, Taipei (TW); Yu-Sheng Wang, Taipei (TW); Yen-Ting Chou, Taipei (TW)

Correspondence Address: JIANQ CHYUN INTELLECTUAL PROPERTY OFFICE, 7 FLOOR-1, NO. 100, ROOSEVELT ROAD, SECTION 2, TAIPEI, 100, TW

(73) Assignee: ASUSTEK COMPUTER INC., Taipei (TW)

(21) Appl. No.: 12/198,075

(22) Filed: Aug. 25, 2008

(30) Foreign Application Priority Data
Sep. 19, 2007 (TW) 96134866

(51) Int. Cl. G06F 1/08

(52) U.S. Cl. 713/600

(57) ABSTRACT

A method for setting an actual operation frequency of a memory is provided. The method includes the following steps. First, a memory model list is provided for selecting a memory model. Then, an estimation operation frequency of the memory is obtained according to the selected model. Finally, the operation frequency of a front side bus (FSB) is adjusted and cooperated with a frequency transformation ratio to generate the actual operation frequency of the memory according to the estimation operation frequency.

### CROSS-REFERENCE TO RELATED APPLICATION

This application claims the priority benefit of Taiwan application serial no. 96134866, filed on Sep. 19, 2007. The entirety of the above-mentioned patent application is hereby incorporated by reference herein and made a part of specification.

### BACKGROUND OF THE INVENTION

1. Field of the Invention

The invention relates to a method for setting the frequency of a memory and, more particularly, to a method for setting the overfrequency of a memory and a setting module thereof.

2. Description of the Related Art

More and more memory module suppliers produce memory modules whose operation frequencies are higher than a common frequency range supported by a chip set. That is, the memory modules can be normally used only after the frequency of the chip set on a motherboard increases, and the operation frequency of a central processing unit (CPU) and other parameters are adjusted.

Generally speaking, a user can set operation frequencies of the CPU and the memory via the setting picture of a basic input output system (BIOS) to realize the overfrequency during a booting process. However, the user needs to set the parameter value of a front side bus (FSB) and the operation frequency of the memory by himself to realize the overfrequency. Furthermore, the user also needs to consider parameters such as the internal frequency, the external frequency and the operation voltage of the CPU, and a common user cannot clearly know the setting relationship of the FSB parameter value, the frequency of the memory and the frequency of the CPU. Therefore, the overfrequency setting cannot be successfully finished.

In the conventional main computer configuration on the market, the frequency of the memory should be proportional to the frequency of the CPU, and it cannot be randomly adjusted, which adds difficulty when the user sets the frequency. The user often only can use the setting “auto” to make a memory module operated under a predetermined frequency, and then the highest performance of the memory cannot be obtained.

### BRIEF SUMMARY OF THE INVENTION

The invention provides a method for setting an operation frequency of a memory and a setting module thereof. An overfrequency setting menu is added into a setting picture of a basic input output system (BIOS), and then a user can directly set the operation frequency of the memory via a model on the package of the memory, and he does not need to set additional parameters such as a front side bus (FSB) parameter. In this way, the process of setting the frequency of the memory is simplified, and the user can easily finish the overfrequency setting.

The invention provides a method for setting an actual operation frequency of a memory, and the method includes the steps of providing a memory model list for selecting a memory model, obtaining an estimation operation frequency of the memory according to the selected memory model and adjusting an operation frequency of a FSB to cooperate with a frequency transformation ratio to generate the actual operation frequency of the memory according to the estimation operation frequency.

In one embodiment of the invention, before the step of providing the memory model list, the method further includes the step of providing a setting picture having an overfrequency setting option, and the memory model list is provided only after the overfrequency setting option is selected. The setting picture is, for example, a setting picture of the BIOS.

In one embodiment of the invention, in the step of adjusting the operation frequency of the FSB to cooperate with the frequency transformation ratio according to the estimation operation frequency of the method, a group of the operation frequency of the FSB and the frequency transformation ratio is selected according to a look-up table comprising a plurality of combinations of the operation frequency of the FSB and the frequency transformation ratio. The step of adjusting the operation frequency of the FSB to cooperate with the frequency transformation ratio according to the estimation operation frequency further includes the step of adjusting an operation voltage of the memory and an operation frequency of a central processing unit (CPU).

The invention further provides a module for setting an actual operation frequency of a memory, and the module includes a display module and a processing module. The display module provides a memory model list including a plurality of memory models. The processing module is connected to the display module and is used for estimating an estimation operation frequency corresponding to one of the memory models, and it adjusts an operation frequency of a FSB to cooperate with a frequency transformation ratio to generate the actual operation frequency of the memory according to the estimation operation frequency.

In one embodiment of the invention, the module further includes a look-up table comprising a plurality of combinations of the operation frequency of the FSB and the frequency transformation ratio for the processing module to adjust the operation frequency of the FSB to cooperate with the frequency transformation ratio. The processing module adjusts the operation voltage of the memory according to the estimation operation frequency. The memory model list includes memory models Memory-6400, Memory-7200, Memory-8000, Memory-8500, Memory-9200, Memory-9600, Memory-10000 and Memory-11000.

Since the function of the invention is integrated into the BIOS system, the BIOS system can be used to directly adjust the FSB parameter, the frequency of the CPU and the frequency of the memory. A user only needs to select a wanted memory model via the overfrequency setting option provided by a user interface, and the other parameters are automatically set in the invention. In this way, the process of setting the frequency of the memory is simplified for the user.

These and other features, aspects, and advantages of the present invention will become better understood with regard to the following description, appended claims, and accompanying drawings.

### BRIEF DESCRIPTION OF THE SEVERAL VIEWS OF THE DRAWINGS

FIG. 1 is a schematic diagram showing a computer system configuration according to one embodiment of the invention;

FIG. 2 is a schematic diagram showing a module for setting the operation frequency of a memory according to one embodiment of the invention;

FIG. 3 is a schematic diagram showing a user interface according to one embodiment of the invention; and

FIG. 4 is a flow chart showing a method for setting the operation frequency of a memory according to another embodiment of the invention.

### DETAILED DESCRIPTION OF THE EMBODIMENTS

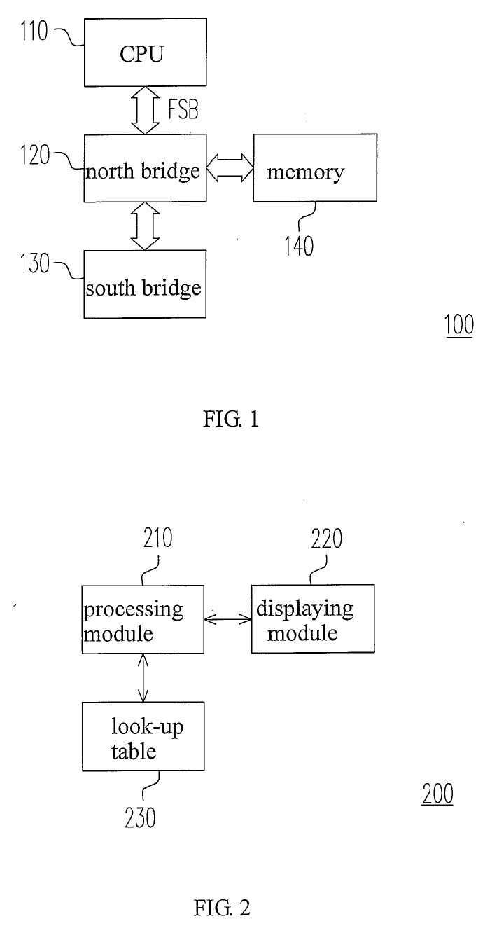

FIG. 1 is a schematic diagram showing a computer system configuration according to one embodiment of the invention. As shown in FIG. 1, a computer system configuration 100 includes a central processing unit (CPU) 110, a north bridge 120, a south bridge 130 and a memory 140. A bus between the north bridge 120 and the CPU 110 is a front side bus (FSB). Since data transmission between the CPU 110 and the south bridge 130, the north bridge 120 and the memory 140 is realized via the FSB, the transmission speed of the FSB affects the operation performance of the whole system. The operation frequency of the CPU 110 is proportional to the operation frequency of the FSB, and it usually is set via an external frequency parameter and a multiplier parameter.

In the main computer configuration (such as Intel), the operation frequencies of the CPU 110, the FSB and the memory 140 are corresponding to each other. The operation frequency values of the memory that are supported by various FSB parameter values can be obtained by calculation. Table 1 lists the operation frequency values of the memory that are supported by the FSB parameter which is three hundred and thirty three.

TABLE 1

| | | operation frequency of the |
|---|---|---|
| FSB parameter | constant ratio | memory (MHz) |
| 333 | 1:1 | 667 |
| 333 | 5:6 | 800 |
| 333 | 4:5 | 833 |
| 333 | 2:3 | 1000 |
| 333 | 5:8 | 1066 |
| 333 | 3:5 | 1110 |
| 333 | 1:2 | 1333 |

In the conventional technology, when the operation frequency value of the memory that is wanted by the user is not listed in Table 1, the user needs to adjust the FSB parameter. For example, when the operation frequency of the memory is 900 MHz, the user needs to change the FSB parameter from the original value three hundred and thirty three to other FSB parameter value such as three hundred and forty five, three hundred and sixty, three hundred and seventy five and so on first, and then he selects different frequency transformation ratio value (the constant ratio values shown in the above table) in the standard to calculate one by one to obtain the frequency of the memory that is supported and adjacent to 900 MHz. It is difficult for a common user to control the above operation, and it is difficult for the common user to combine the standard such as Memory-9600 displayed at the external surface of the memory with the setting of operation frequency of the memory. Therefore, to obtain the best setting or to realize the overfrequency setting is difficult.

The embodiment provides a module for setting an actual operation frequency of a memory, and the above FSB parameter and the corresponding operation frequency of the memory are stored in a look-up table. Therefore, a user only needs to set the memory model, and the module for setting the actual operation frequency of the memory searches for a suitable FSB parameter value in the look-up table to simplify the process of setting the frequency of the memory for the user. FIG. 2 is a schematic diagram showing a module for setting the operation frequency of a memory according to the embodiment. A setting module 200 includes a processing module 210, a display module 220 and a look-up table 230. The display module 220 provides a memory model list for listing supported memory models such as Memory-6400, Memory-7200, Memory-8000, Memory-8500, Memory-9200, Memory-9600, Memory-10000, Memory-11000. When the user selects one of the memory models, the processing module 210 connected to the display module 220 estimates an estimation operation frequency corresponding to the memory model. For example, when the memory model is Memory-7200, the corresponding estimation operation frequency is 900 MHz (7200/8). Then, based on the estimation operation frequency 900 MHz, the operation frequency of the FSB is adjusted to cooperate with a frequency transformation ratio to generate an operation frequency which is adjacent to 900 MHz and used as the actual operation frequency of the memory. Furthermore, a look-up table 230 is provided to store combinations of the operation frequency of the FSB and the frequency transformation ratio to accelerate the process of the processing module 210.

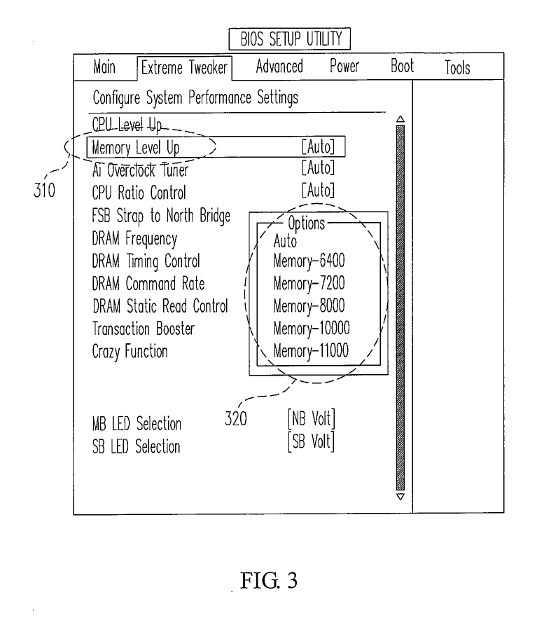

The display module 220 may, for example, be directly integrated into the setting picture of the BIOS to provide an overfrequency setting option (shown in FIG. 3 and named Memory Level Up) for a user to select the memory model. The memory model list can list the supported memory models such as Memory-6400, Memory-7200, Memory-8000, Memory-8500, Memory-9200, Memory-9600, Memory-10000, Memory-1000. Different memory model is corresponding to a different predetermined operation frequency. For example, the memory model Memory-6400 is corresponding to 800 MHz, and the memory model Memory-7200 is corresponding to 900 MHz. Generally speaking, the operation frequency increases along with the increase of the corresponding memory model. The user can select one memory model from the memory model list, and the setting module 200 can set the operation frequency of the memory 140 and the corresponding operation frequency of the FSB according to the selected memory model. As for the setting of the operation frequency of the FSB, the setting module 200 can directly set and store the corresponding operation frequency (the FSB parameters in Table 1) of the FSB and the corresponding frequency transformation ratio (the constant ratio values in Table 1) according to the look-up table 230. A plurality of common memory models and corresponding FSB parameter values are shown in Table 2 to illustrate the look-up table 230.

TABLE 2

| | FSB | | | constant |
|---|---|---|---|---|
| memory model | parameter | constant ratio | FSB parameter | ratio |
| Memory-6400 | 266 | 2:3 | 333 | 5:6 |
| Memory-7200 | 270 | 3:5 | 360 | 4:5 |
| Memory-8000 | 300 | 3:5 | 333 | 2:3 |
| Memory-8500 | 266 | 1:2 | 333 | 5:8 |
| Memory-9200 | 288 | 1:2 | 345 | 3:5 |
| Memory-9600 | 300 | 1:2 | 360 | 3:5 |
| Memory-10000 | 313 | 1:2 | 375 | 3:5 |
| Memory-11000 | 344 | 1:2 | 344 | 1:2 |

As shown in Table 2, taken the model Memory-9600 as an example, the operation frequency of the memory is 9600/8=1200 MHz and is corresponding to the FSB parameter that is three hundred cooperating with the constant ratio that is 1:2 and the FSB parameter that is three hundred and sixty cooperating with the constant ratio that is 3:5. The operation frequency of the memory corresponding to the FSB parameter that is three hundred cooperating with the constant ratio that is 1:2 is 300*(2/1)*2=1200 MHz; the operation frequency of the memory corresponding to the FSB parameter that is three hundred and sixty cooperating with the constant ratio that is 3:5 is 360*(5/3)*2=1200 MHz. The look-up table 230 can be directly stored into the memory (such as a flash memory) of the BIOS.

In other words, when the user selects “Memory-9600”, the setting module 200 adjusts the operation frequency of the memory 140 to be 1200 MHz and adjusts the FSB parameter to be three hundred or three hundred and sixty. Generally speaking, the setting module 200 selects a value adjacent to a predetermined operation frequency of the FSB to set the operation frequency of the FSB. That is, the setting module 200 selects the value adjacent to the predetermined value of the FSB parameter to adjust. If the predetermined value of the FSB parameter is three hundred and thirty three, the setting module 200 adjusts the FSB parameter to be three hundred and sixty; if the predetermined value of the FSB parameter is two hundred and sixty six, the setting module 200 adjusts the FSB parameter to be three hundred.

The needed voltage increases along with the increase of the operation frequency of the memory. The setting module 200 also adjusts the operation voltage of the memory 140 according to the memory model set by the user at the same time. For example, the operation voltage is adjusted to be 2.3V to 2.5V from 1.8V. Furthermore, the process of selecting the FSB parameter also can be realized in a software calculation mode, and the estimation operation frequency corresponding to the memory model is directly calculated out. Then, the corresponding FSB parameter (namely, the corresponding operation frequency of the FSB) cooperating with a frequency transformation ratio is obtained. In the embodiment, the mode of obtaining FSB parameter is not limited to the mode of looking up the table.

To illustrate the embodiment of the invention, FIG. 3 is a schematic diagram showing a user interface according to the embodiment. As shown in FIG. 3, the display module 220 provides an overfrequency setting option 310 in the setting picture of the BIOS. That is, the overfrequency setting option 310 is “Memory Level Up” in FIG. 3. When the user selects the option, the picture displays the memory model list 320 for the user to select, and the operation mode of the memory model list 320 is the same with the operation mode of the common BIOS setting, and it is not described for concise purpose. Since the function of the embodiment can be directly integrated into the BIOS and utilizes common functions supported by the BIOS, the other content in FIG. 3 is a common setting picture of the BIOS and is not described for concise purpose. The user interface shown in FIG. 3 is an implementing mode of the invention, and the invention is not limited to it.

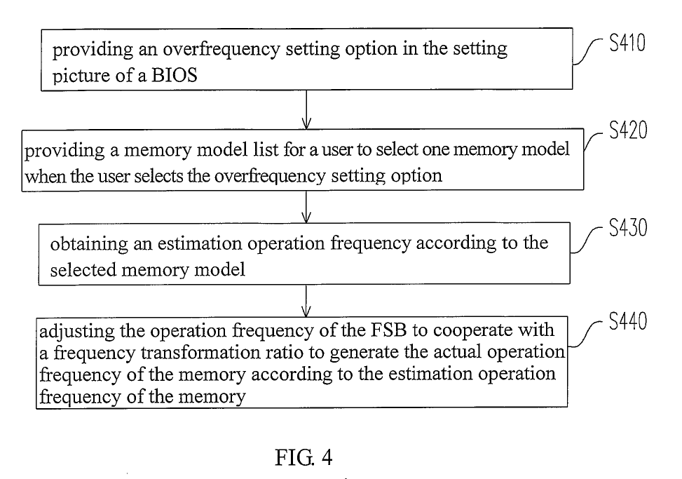

The invention provides a method for setting the operation frequency of a memory. As shown in FIG. 3 and FIG. 4, FIG. 4 is a flow chart showing a method for setting the operation frequency of a memory according to another embodiment of the invention. In the embodiment, the operation frequencies of a memory and a FSB are suitable to be adjusted. First, in the step S410, the setting picture of the BIOS provides an overfrequency setting option 310 (the “Memory Level Up” option in FIG. 3); then, when the user selects the overfrequency setting option 310, a memory model list 320 is provided for the user to select one memory model (such as the memory models Memory-6400, Memory-7200 in FIG. 3) (the step S420). Afterward, in the step S430, an estimation operation frequency of the memory is obtained according to the selected memory model (the step S430); according to the estimation operation frequency of the memory, the operation frequency of the FSB is adjusted to cooperate with a frequency transformation ratio to generate the actual operation frequency of the memory (the step S440).

In the step S440, a group of the operation frequency of the FSB and the frequency transformation ratio is selected according to a look-up table. The operation voltage of the memory is set according to the actual operation frequency of the memory. The operation frequency of the central processing unit (CPU) is set according to the operation frequency of the FSB. Other detail of the method for setting the frequency of the memory is similar to the description about the module for setting the frequency of the memory and is not described for concise purpose.

To sum up, in the invention, the memory model is directly used as the basis of setting the operation frequency of the memory, and therefore, the user can precisely set the operation frequency of the memory only according to the memory model shown on the package of the memory without any complicated setting process. Furthermore, when the user wants to realize an overfrequency setting, he only needs to select a higher memory model, and the system correspondingly sets the operation voltage of the memory, the FSB parameter, the operation frequency of the CPU and so on. The user can successfully set the operation frequencies of the memory and the system without any additional overfrequency knowledge, and then the complexity of setting the operation frequency of the memory for the user decreases.

Although the present invention has been described in considerable detail with reference to certain preferred embodiments thereof, the disclosure is not for limiting the scope of the invention. Persons having ordinary skill in the art may make various modifications and changes without departing from the scope and spirit of the invention. Therefore, the scope of the appended claims should not be limited to the description of the preferred embodiments described above.

What is claimed is:

1. A method for setting an actual operation frequency of a memory, the method comprising the steps of:
providing a memory model list for selecting a memory model;
obtaining an estimation operation frequency of the memory according to the selected memory model; and
adjusting an operation frequency of a front side bus (FSB) to cooperate with a frequency transformation ratio to generate the actual operation frequency of the memory according to the estimation operation frequency.

2. The method according to claim 1, wherein before the step of providing the memory model list, the method further comprises the step of providing a setting picture comprising an overfrequency setting option, and the memory model list is provided when the overfrequency setting option is selected.

3. The method according to claim 2, wherein the setting picture is a setting picture of a basic input output system (BIOS).

4. The method according to claim 1, wherein in the step of adjusting the operation frequency of the FSB to cooperate with the frequency transformation ratio according to the estimation operation frequency, a group of operation frequency of the FSB and a frequency transformation ratio is selected according to a look-up table comprising a plurality of combinations of operation frequency of the FSB and the frequency transformation ratio.

5. The method according to claim 1, wherein the step of adjusting the operation frequency of the FSB to cooperate with the frequency transformation ratio according to the estimation operation frequency further comprises the step of adjusting an operation voltage of the memory.

6. The method according to claim 1, wherein the step of adjusting the operation frequency of the FSB to cooperate with the frequency transformation ratio according to the estimation operation frequency further comprises the step of adjusting an operation frequency of a central processing unit (CPU) according to the operation frequency of the FSB.

7. A module for setting an actual operation frequency of a memory, the module comprising:
a display module providing a memory model list comprising a plurality of memory models; and
a processing module connected to the display module and used to estimate an estimation operation frequency corresponding to one of the memory models, wherein the processing module adjusts an operation frequency of a FSB to cooperate with a frequency transformation ratio to generate the actual operation frequency of the memory according to the estimation operation frequency.

8. The module according to claim 7, wherein the setting module further comprises a look-up table storing a plurality of combinations of the operation frequency of the FSB and the frequency transformation ratio for the processing module to adjust the operation frequency of the FSB to cooperate with the frequency transformation ratio.

9. The module according to claim 7, wherein the processing module further adjusts an operation voltage of the memory according to the estimation operation frequency.

10. The module according to claim 7, wherein the memory model list comprises memory models Memory-6400, Memory-7200, Memory-8000, Memory-8500, Memory-9200, Memory-9600, Memory-10000 and Memory-11000.
